(19) United States
(12) Patent Application Publication
(10) Pub. No.: US 2003/0135304 A1
(43) Pub. Date: Jul. 17, 2003

(54) System and method for managing transportation assets

(76) Inventors: Brian Sroub, Cupertino, CA (US); James Mackraz, Palo Alto, CA (US)

Correspondence Address: CALFEE HALTER & GRISWOLD, LLP, 800 SUPERIOR AVENUE, SUITE 1400, CLEVELAND, OH, 44114, US

(21) Appl. No.: 10/339,937

(22) Filed: Jan. 10, 2003

Related U.S. Application Data
(60) Provisional application No. 60/347,692, filed on Jan. 11, 2002.

(51) Int. Cl. G06F 17/60

(52) U.S. Cl. 701/1; 705/1

(57) ABSTRACT

A system for managing transportation assets is provided. The system provides for dynamically (re)computing a trip route based on a real-time updateable stochastic model of a transportation network. The system includes an experience based database for storing a dynamic map data, passive data gatherers that periodically update the experience based database and a processor for (re)computing a trip route based on the experience based database and the stochastic model as influenced by the real-time transportation network data.

It is emphasized that this abstract is provided to comply with the rules requiring an abstract that will allow a searcher or other reader to quickly ascertain the subject matter of the application. It is submitted with the understanding that it will not be used to interpret or limit the scope or meaning of the claims.

### CROSS REFERENCE TO RELATED APPLICATIONS

This application claims the benefit of U.S. Provisional Application 60/347,692, filed Jan. 11, 2002, which is incorporated herein by reference.

### TECHNICAL FIELD

The systems, methods, application programming interfaces (API), data packets and computer readable media described herein relate generally to transportation management systems and more particularly to efficiently transporting goods, freight, materials, food, perishables and/or personal vehicular traffic based, at least in part, on analyzing and correlating real-time experience data with historical data to facilitate computing routing information.

### BACKGROUND

Transportation systems are the backbone of modem economies. Efficient transportation is highly valuable, lowering expenses, reducing pollution, and utilizing expensive transportation assets so that they are more often moving goods and services and less often traveling empty or inefficiently. Although computers have been employed in transportation systems, logistical systems and planning have not delivered the improvements that Enterprise Resource Planning (ERP) and Just In Time (JIT) systems have delivered to other industries. Numerous methods and devices have been developed to move goods and people efficiently from point to point. These methods include systems that enable vehicles involved in transportation to be tracked and monitored. For example, U.S. Pat. No. 5,428,546 (Shah, et al.) issued Jun. 27, 1995 describes a system for tracking vehicle locations and displaying the locations via visual monitoring devices. Shah and similar systems enable a remote user to track vehicles in real-time but are largely focused on the problem of theft recovery. There are also systems for managing traffic information. For example, U.S. Pat. No. 5,465,289 (Kennedy) issued Nov. 7, 1995, describes a method for providing vehicle traffic information using cellular telephone technology. U.S. Pat. No. 5,299,132 (Wortham) issued Mar. 29, 1994 facilitates locating vehicles through cellular telephone technology. U.S. Pat. No. 5,317,323 (Kennedy et al.) issued May 31, 1994 describes a vehicle locating system utilizing Global Positioning Satellite System (GPS) and cellular telephones. U.S. Pat. No. 5,396,429 (Hanchett) issued Mar. 7, 1995, employs roadway sensors and cameras for monitoring traffic flow. Other systems facilitate monitoring vehicle security with respect to theft and tampering, as described for example in U.S. Pat. No. 5,218,367 (Sheffer et al.) issued Jun. 8, 1993. U.S. Pat. No. 6,304,816 (Berstis) issued Oct. 16, 2001 describes a method and apparatus for automatic data collection from vehicles that facilitates inferring current traffic conditions.

### SUMMARY

The following presents a simplified summary of methods, systems, computer readable media and so on for managing transportation assets to facilitate providing a basic understanding of these items. This summary is not an extensive overview and is not intended to identify key or critical elements of the methods, systems, computer readable media, and so on or to delineate the scope of these items. This summary provides a conceptual introduction in a simplified form as a prelude to the more detailed description that is presented later.

Certain illustrative example methods, systems, computer readable media and so on are described herein in connection with the following description and the annexed drawings. These examples are indicative, however, of but a few of the various ways in which the principles of the methods, systems, computer readable media and so on may be employed and thus are intended to be inclusive of equivalents. Other advantages and novel features may become apparent from the following detailed description when considered in conjunction with the drawings.

The example systems and methods described herein facilitate merging real-time data gathered by a transportation asset (e.g. car, truck, boat, plane, vehicle) traveling through a transportation landscape with historical data (e.g., vehicle, trip, route, user profile) stored in an experience based travel database to facilitate improving routing decisions. Improved routing decisions facilitate accurately calculating trip duration and reducing variability in vehicle arrival time predictions. The historical data may be stored in one or more databases that are populated with passively gathered data, for example. The experience based travel database(s) correlate static data (e.g., read location) with dynamic data (e.g., weather, time of day) and experience data (e.g., average speed during certain weather at certain time). The systems and methods described herein facilitate improving accuracy and reliability by, for example, computing an initial route and/or schedule for a trip using a statistical model that considers a set of vehicle management parameters and updating the initial route based on real-time events (e.g., traffic, vehicle conditions, safety concerns, fuel concerns), where the real-time data can be correlated with and/or interpreted in light of the passively gathered data stored in the database(s). The updating can be based, for example, on deterministic data and/or inferences about travel conditions for which no real-time data is available. Inferences can be predicated on real-time data gathered by a vehicle as it progresses along a route and/or external data (e.g., weather reports). Furthermore, the systems and methods described herein consider factors like time of day and user profiles when making (re)routing decisions.

### BRIEF DESCRIPTION OF THE DRAWINGS

FIG. 1 illustrates a system that facilitates managing transportation assets.

FIG. 2 is an example dynamic routing system diagram.

FIG. 3 illustrates an example method for managing transportation assets.

FIG. 4 illustrates an example configuration of a system that facilitates managing transportation assets.

FIG. 5 illustrates two segments of a transportation network.

FIG. 6 illustrates several segments of a transportation network.

FIG. 7 illustrates several segments of a transportation network.

FIG. 8 is a schematic block diagram of an example computing environment in which the present invention can be employed.

FIG. 9 illustrates an example data packet employed in systems and methods for managing transportation assets.

FIG. 10 illustrates example subfields in a data packet employed in systems and methods for managing transportation assets.

FIG. 11 illustrates an example API employed with systems and methods for managing transportation assets.

### DETAILED DESCRIPTION

Example systems, methods, computer media, and so on are now described with reference to the drawings, where like reference numerals are used to refer to like elements throughout. In the following description, for purposes of explanation, numerous specific details are set forth in order to facilitate thoroughly understanding the methods, systems, computer readable media and so on. It may be evident, however, that the methods, systems and so on can be practiced without these specific details. In other instances, well-known structures and devices are shown in block diagram form in order to simplify description.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Computer communications”, as used herein, refers to a communication between two or more computer components and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer, computer component and/or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners. It will be appreciated by one of ordinary skill in the art that the form of software may be dependent on, for example, requirements of a desired application, the environment in which it runs, and/or the desires of a designer/programmer or the like.

An “operable connection” (or a connection by which entities are “operably connected”) is one in which signals, physical communication flow and/or logical communication flow may be sent and/or received. Usually, an operable connection includes a physical interface, an electrical interface, and/or a data interface, but it is to be noted that an operable connection may consist of differing combinations of these or other types of connections sufficient to allow operable control.

“Data store”, as used herein, refers to a physical and/or logical entity that can store data. A data store may be, for example, a database, a table, a file, a list, a queue, a heap, and so on. A data store may reside in one logical and/or physical entity and/or may be distributed between two or more logical and/or physical entities.

It will be appreciated that some or all of the processes and methods of the system involve electronic and/or software applications that may be dynamic and flexible processes so that they may be performed in other sequences different than those described herein. It will also be appreciated by one of ordinary skill in the art that elements embodied as software may be implemented using various programming approaches such as machine language, procedural, object oriented, and/or artificial intelligence techniques.

The processing, analyses, and/or other functions described herein may also be implemented by functionally equivalent circuits like a digital signal processor circuit, a software controlled microprocessor, or an application specific integrated circuit. Components implemented as software are not limited to any particular programming language. Rather, the description herein provides the information one skilled in the art may use to fabricate circuits or to generate computer software to perform the processing of the system. It will be appreciated that some or all of the functions and/or behaviors of the present system and method may be implemented as logic as defined above.

Typically, when deciding on a route, a decision maker will consult a map. Conventionally, maps have recorded the location of roads, flight corridors, navigable portions of waterways, landmarks and the like. Some maps are annotated with information like typical travel times and speeds allowed. These annotations facilitate making good routing decisions. However, conventional maps become out of date, and the typical times and speeds can bear little relation to actual conditions. For example, a section of interstate highway may be mapped between two cities, and the highway may be annotated with typical travel times and allowable speeds. However, the interstate highway may pass through an area that experiences significant rush hour traffic. Thus, the travel experience encountered on this stretch of highway will vary greatly depending on the time of day, and the day of the week on which it is traveled. Furthermore, the interstate highway may pass by a stadium, whose event traffic can also affect the travel experience. Further still, the interstate highway may pass through a hazardous material free zone through which certain cargoes may not pass. Thus, conventional maps, while better than having no map at all to help make routing decisions, do not incorporate experience based information and do not reflect dynamic conditions.

Thus, the systems and methods described herein facilitate storing more information about a route than is found in conventional maps. They also facilitate correlating real-time data concerning a vehicle, (e.g., current location, current time, current date) with stored map, route and/or user information to produce a better routing decision, a more accurate arrival time prediction and to facilitate, as necessary, re-routing a vehicle to account for instant conditions. The correlations can be collected over time to build out the experience based travel database.

Another limitation with conventional maps and/or routing methods is that information about one piece of highway is typically not correlated with other pieces of highway. For example, a map may indicate that three two-lane roads connect to a four-lane road along a one mile length of highway. An annotated map may contain distances between the roads and typical travel times. While this provides route information, it does not consider the impact that instant conditions on one section of road may have on other sections of road. For example, a traffic event (e.g., accident) on one of the feeder two-lane roads may have no impact on the four-lane road. However, an accident on the four-lane road may seriously impact the two-lane roads. Thus, the example systems and methods described herein facilitate receiving traffic event information associated with one section of a transportation network and propagating the predicted effect of such an event on other sections. Thus, rather than basing a routing and/or scheduling decision on a static map with predicted average times, the systems and methods associated herein facilitate making a real-time (re)routing and/or (re)scheduling decision based on a real-time data updated model. Furthermore, the effects of various traffic events can be collected over time to further build out the experience based travel database.

The systems and methods described herein facilitate correlating historical data with real-time data, maximizing the value of real-time data in producing transportation asset management optimizations in route selection and delivery time predictions. One example produces comprehensive map, trip, vehicle and/or user aggregations and correlations across times and conditions while another example provides real-time reduction of a model to facilitate responding to queries (e.g., route requests) by running real-time simulations. The correlations can be employed, for example, to facilitate transportation resource planning (TRP), whereby efficiency improvements over conventional systems, like reducing empty backhauls and reducing driver idle time are possible. By way of illustration, in conventional systems, due to the variability in predicted arrival time, transportation assets may travel empty, since a first load for which an asset is waiting has not arrived on time, and a second load that the asset must pick up cannot wait. However, if the variability in predicted arrival time is reduced, then advantages including reducing the percentage of empty backhauls and reducing driver idle time can be achieved.

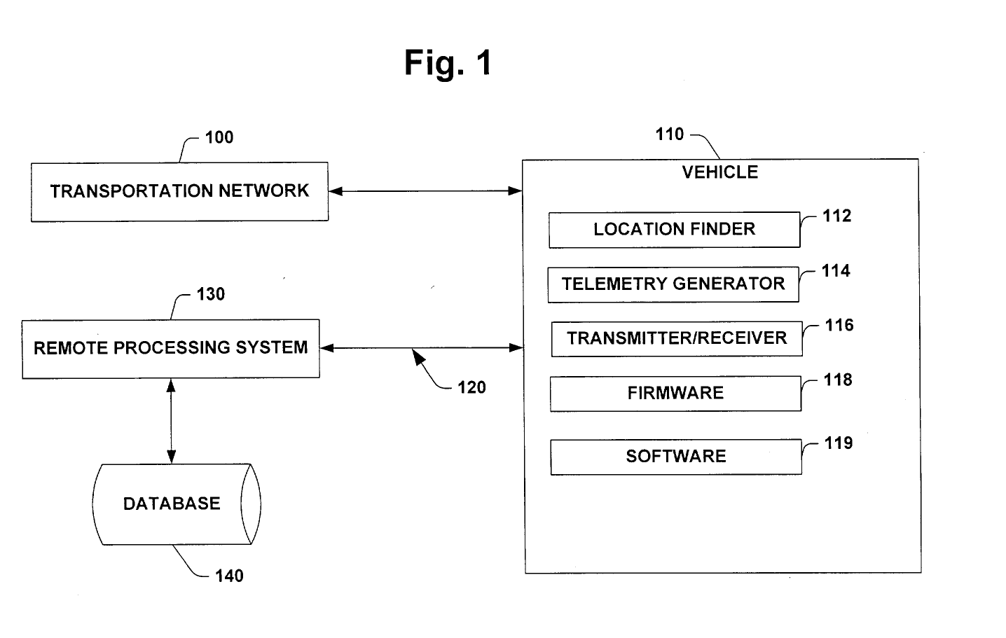

FIG. 1 illustrates a system for improving transportation management efficiency. A transportation network 100 is navigated by a vehicle 110. The vehicle 110 may be, for example, a truck delivering a cargo. More generally, the vehicle 110 can be a transportation asset. The vehicle 110 includes a location finder 112, a telemetry generator 114, a transmitter/receiver 116, firmware 118, and software 119. The location finder 112 may be, for example, a GPS system. The telemetry generator 114 can generate data including, for example, direction, speed, fuel status, ambient temperature and the like, which can be passively collected in the database 140. The transmitter/receiver 116 can transmit location and telemetry data and receive asset management data. The transmitter/receiver 116 may, for example, transmit/receive telemetry and/or route data as a computer communication via one or more signals. The firmware 118 and/or software 119 can store computer executable instructions for performing functions associated with asset management. By way of illustration, the location finder 112 may be controlled by the firmware 118 and/or software 119. By way of further illustration, the telemetry generator 114 may be programmed to generate different sets of telemetry data based on instructions coded in the firmware 118 and/or software 119. Thus, it is to be appreciated that the location finder 112, telemetry generator 114, and other illustrated elements can be embodied as computer components.

The vehicle 110 transmits and receives data over a wireless network 120 to a remote processing system (RPS) 130. The RPS 130 accesses and/or manages a database 140 that stores information including, but not limited to, map data, map annotations, a transportation predictive model, a route finding model and so on. The database 140 may also store one or more route and/or driver profiles derived from the passively gathered data. The RPS 130 thus integrates real-time data received from the vehicle 110 with data stored in the database 140 to (re)compute route and predicted arrival time information. Such information can be transmitted over the wireless network 120. It is to be appreciated that the RPS 130 may include, for example, a variety of stand alone, distributed, networked and/or communicating processes, processors and/or threads.

Example system components may include, but are not limited to a unit inside the vehicle for displaying information, a unit for detecting vehicle location, a unit for generating telemetry data, a unit for transmitting the vehicle location and/or telemetry data to a remote processing system (RPS), a unit for transmitting information, data, and/or analysis to the vehicular unit, a timer, analysis software associated with the RPS to record and/or analyze trip information and a processing system that combines historical analysis with real-time vehicle data to facilitate predicting route time and variance. The processor can perform methods including, but not limited to, a method for automatically gathering, organizing and storing route, map, trip, vehicle and/or user data in database, a method for converting individual latitude/longitude observations into road segments, and a method for generating route recommendations, navigational assists and network management recommendations.

The processing system locates the vehicle in real-time by, for example, interacting with signals generated from an on-board GPS. The processing system can determine and mark the initial and final points of a vehicle on its journey. Since a vehicle may encounter temporary travel interruptions during a journey, interruptions can be discriminated from the initial/final points and times by automated analysis and/or manual operator input. The initial and final points of a vehicle are logged with respect to parameters including, but not limited to, the temporal interval, the mileage traversed, the route segments, the time of day, and day of week and date. A database associated with the processing system stores the data and/or relationships between the data to facilitate providing routing information based on actual data rather than mileage/speed limit computations. Thus, in one example, the database may be substantially constantly updated with data gathered about the transportation network. The processing system may be, for example, a stand alone processor and/or a distributed network of processors, processes and/or threads.

Reporting and recording relevant vehicle information during a trip segment might saturate a system's ability to transmit data via cellular phone or pager technology as well as saturating data storage and analysis systems and methods. Therefore, one example facilitates transmitting and receiving manageable data transmissions from remote units. The transmissions can occur at programmed intervals, in response to vehicle operator manual input, and/or by interrogation from the processing system, for example. Interrogation involves a processing system sending a telemetric query that prompts data reporting from transportation assets in the field. Also, trip information may be recorded remotely and later downloaded for subsequent analysis by the processing system. This facilitates providing trip histories while mitigating problems associated with saturating communication capabilities.

A vehicle unit may also accept direct driver input including, but not limited to, inputs associated with mechanical breakdowns, accidents, traffic, trains, road construction, school zones, special events (e.g., sporting events causing high traffic congestion) and other significant traffic disturbances. This data can be transmitted to a remote processing system. Additionally, the unit on the vehicle may contain a display system that displays mapping information similar to that found in conventional GPS systems, which can accept information resulting from the analysis by the remote processing system. The information can provide updated routing information, for example. The remote processing system can be connected to traffic monitoring systems for real-time traffic updates, and/or the updates can be entered manually. Manual updates may be provided by, for example, keyboard entry, mouse designation from a system of menus, voice recognition software, and the like. For example, scheduled road construction, sporting events, school zone operations, forecasted inclement weather conditions, and the like can be manually entered into the database.

Passively collected real-time information is also available for improving routing operations and reducing variability in arrival times. The information may be sent, for example, in packets or bursts of encoded encrypted, and/or compressed data. Information may be transmitted across networks employing, for example, Code Division Multiple Access (CDMA), Time Division Multiple Access (TDMA), analog cellular (e.g. AMPS), GSM, 802.11, GPRS, SMS, and standard pager networks such as Reflex, CDPD, and Mobitex and so on.

Over time, the experience based travel database will accumulate actual routing information as a function of vehicle type, time of day, weather condition, traffic condition, user preferences, user habits and road conditions (e.g., construction activities), for example. The database will also accumulate profile information. Profile information can include data that facilitates distinguishing cars from trucks from busses and so on, fast drivers from slow drivers, single passenger cars from car poolers, and so on. Vehicles and/or drivers with different profiles traverse routes using different characteristics. Thus, route generation can be influenced and/or determined by individual profiles. The information in the database is analyzed to facilitate determining the most efficient route to a given location. In one example, the efficiency of a route may be determined by examining mean travel time and travel time variance. In another example, efficiency may be a function of safety rather than time. Optimization processes analyze the experiences of transits through network segments as a function of time, weather, day of week, type of vehicle, load, driver, and the like, and examine plausible alternate routes that facilitate avoiding congested areas, operational times when traffic is at its peak, and events like school operations with reduced speed limits and slow bus traffic. Comparison of predicted versus actual travel results facilitates further refining optimization processes and thus achieving greater efficiencies.

Traffic events that occur after determining initial routing may result in adjusting the route. For example, a bridge closure on a route may require a notification that an alternate route is desirable. An adjustment can be transmitted to a vehicle for display on its moving map screen. The adjustment may be accompanied, for example, by an audible or visual reminder or by spoken instruction.

The systems and methods described herein facilitate managing commercial delivery, merchandise delivery, document delivery, parcel delivery, freight delivery, material delivery, food delivery, perishable delivery, packet delivery, and the like. However, they can also be employed in personal and business ground transportation. The systems and methods facilitate two or more users sharing real-time information and facilitate two or more users sharing data bases, either in real-time or periodically as updates occur. The users can include, for example, governmental fleets and school bus systems. School bus systems, where breakdowns and mis-scheduling are fairly common events, can benefit from the improved management provided by integrating real-time data with experimental and/or passively acquired historical data.

One example system facilitates tracking the progress of shipments of hazardous materials like flammable fuel, explosives, hazardous wastes (chemical, biological, nuclear, and the like) by government agencies to monitor delivery and/or identify divergence from planned progress. By way of illustration, one example system can be programmed to query for a vehicle or unit location at specific time intervals, to compare the locations against a preprogrammed route, and to produce an alarm condition if the actual location varies from the planned location by more than a pre-determined configurable threshold. Thus, the example system could be employed in anti-terrorist activities.

Example systems can develop profiles of individual drivers and their specific habits, practices, and/or needs, thus selecting routes that are optimal for transit time, transit time dependability, and/or safety, for example. By way of illustration, for some users the fastest mean transit time is less important than providing for a route that is most predictable with respect to travel time, safety or arrival time variability. Variability as used herein comprises the range of uncertainty in the time of the trip conclusion. Uncertainty can be caused by traffic conditions, weather, accidents, the need to refuel or perform maintenance, and the like. The trip variability reducing system can be preset to select routes that may provide a longer mean trip time but with a lower average deviation around the expected result over several trips based on a user cost definition. When computing an optimal route, the systems and methods may cost various route segments differently based on the user cost definition. For example, a first user cost definition may indicate that arrival time predictability is the most important consideration in segment costing. A second user cost definition may indicate that safety is the most important segment costing consideration. Thus, based on the user cost definitions, the first and second user may be presented with different routing choices.

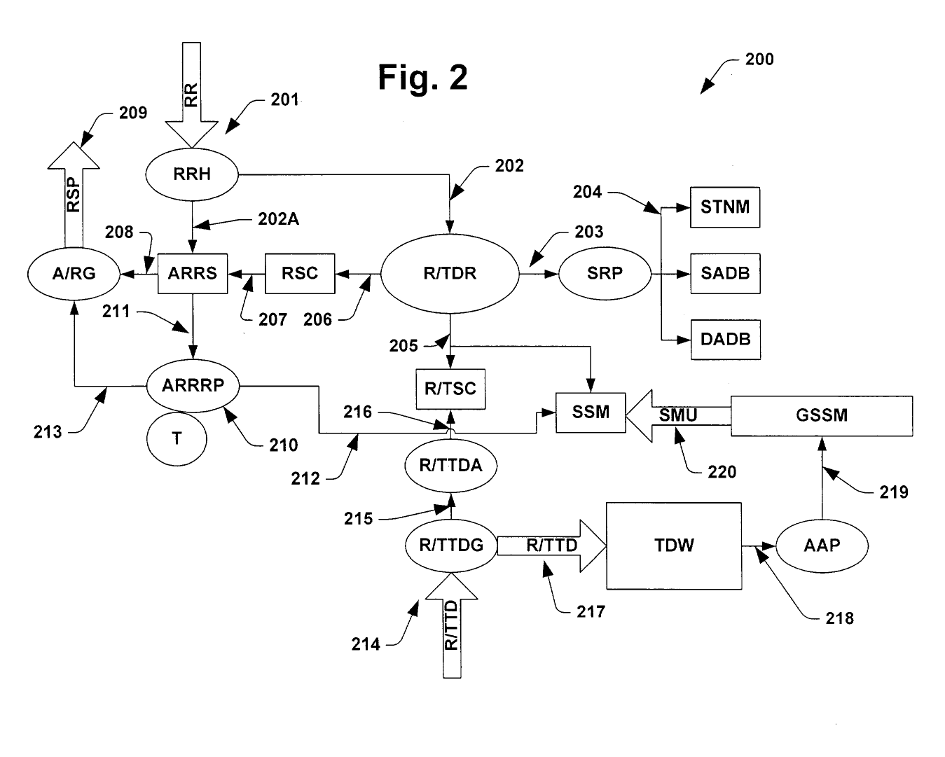

FIG. 2 illustrates an example dynamic routing system 200 for managing transportation assets. The system 200 inputs route requests (RR) and outputs routing information. The system 200 relies on a stochastic simulator model that is updated with real-time data used to manipulate coefficients employed in real-time simulations of transportation network activity. While a stochastic model is described, it is to be appreciated that other models (e.g., chaos theory based) may be employed.

Route requests (RR) arrive 201 at a routing request handler (RRH) from client systems. The route request handler transfers 202 requests to a real-time dynamic router (R/TDR) and registers 202A the active request in an active route request store (ARRS). The real-time dynamic router requests 203 best guess nominated routes from a static route planner (SRP) based on analyzable 204 data stored in a static traffic network map (STNM), a static attribute database (SADB), and/or dynamic attribute (e.g., road closings) database (DADB). The analyzable data can be shared in one or more data stores.

The real-time dynamic router runs 205 simulations of nominated routes through a stochastic simulator model (SSM) in the presence of current real-time simulation coefficients (R/TSC). Resulting best route solutions are transferred 206 through a route selection cache (RSC) out 207 to the active route request store where they are associated with the original route request and transferred 208 to the alert and response gateway (A/RG) for return to the requestor 209.

Until the route request lapses due to time or is cancelled by a client, the active route request review processor (ARRRP) periodically reviews 210 outstanding route plans 211. Route solutions and/or rejected alternatives are selectively re-evaluated 212 to insure they remain a best route considering travel expected and/or reported from a client. Recommended changes in travel plans that employ newly-best-case solutions are made available to clients or posted 213 to the client alerting system.

Substantially constant updating of real-time traffic information in the form of real-time traffic data (R/TTD) is accepted 214 into a real-time traffic data gateway (R/TTDG), aggregated 215 by the real-time traffic data aggregator (R/TTDA) to eliminate outliers and reduce the amount of real-time traffic data, and then employed to update 216 the real-time simulation coefficients (R/TSC).

Real-time traffic data (R/TTD) is also transferred 217 to an offline traffic data warehouse (TDW) for analytical processing 218 in the AAP to update 219 a global stochastic simulation model (GSSM). Global stochastic simulation model updates (SMU) are distributed 220 to real-time processing components for ongoing performance improvements. While various computer components are illustrated as operably connected and communicating to cooperatively process route requests, it is to be appreciated that FIG. 2 illustrates one example configuration and that other configurations are possible. Furthermore, illustrated components may be combined into larger components and/or subdivided into smaller components.

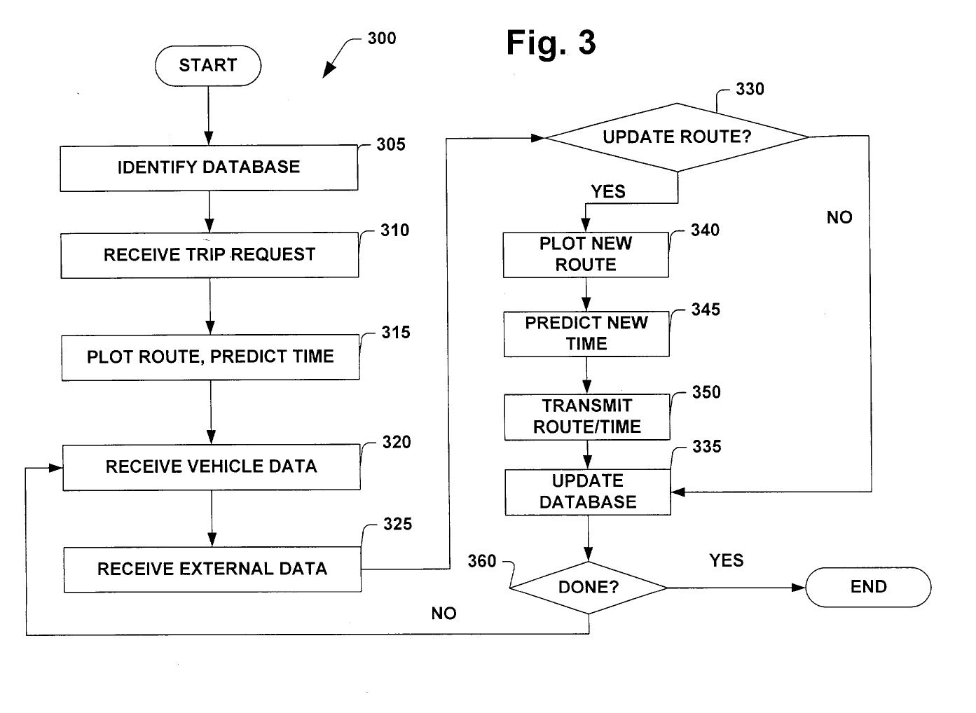

In view of the exemplary systems shown and described herein, example methodologies that are implemented will be better appreciated with reference to the flow diagram of FIG. 3. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies are implemented as computer executable instructions and/or operations, stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, initialization of loops and variables, routine loops, and so on are not shown.

FIG. 3 is a flow chart illustrating an example method 300 for integrating real-time vehicle information with a historical database to facilitate managing transportation assets. In one example, the management results in reducing variability in arrival times. At 305, a historical database with which the method will interact is identified and communication is established with it. The historical database may have been constructed and/or updated in a self-populating manner that organized passively collected data, and/or may have been acquired from a third party, for example. The database may store information including, but not limited to, map data, route data, trip data, vehicle data, and user data. At 310, a trip request is received. For example, a transportation asset manager may desire to schedule and route a vehicle so that a desired delivery time is achieved.

At 315, a route and a predicted delivery time are computed. In one example, multiple possible routes and delivery times are computed and presented to a user via a graphical user interface. The user then selects an optimal route from the possible routes and the vehicle is routed and scheduled and can begin its trip.

At 320, real-time data is received from one or more vehicles. For example, data including, but not limited to, vehicle location, direction, speed, fuel status, oil pressure, oil temperature, ambient temperature and the like can be transmitted. It is to be appreciated that vehicle information can be received from both the vehicle that was scheduled and routed at 315 and from other vehicles that are reporting vehicle data. It is to be further appreciated that data can be received at substantially all points in time. At 325, external data is received. For example, weather data, traffic data, special event data and the like can be received from external sources. The external sources can include, for example, satellites and roadside cameras or sensors.

At 330, a determination is made concerning whether the route and/or time prediction currently in place for the vehicle should be updated. If the determination at 330 is YES, then at 340, a new route is plotted and at 345 a new arrival time is predicted. The new route and new arrival time can be based, for example, on modeling that integrates information stored in the historical data base with the real-time data acquired from the traveling vehicle, other vehicles and other sources. At 350, new route information and arrival time predictions can be transmitted to the vehicle and other parties (e.g., the destination awaiting the vehicle).

At 335, the database can be updated. For example, while the database may store predicted average times for traversing a stretch of highway, recent traversal data may be available that will affect the prediction. Thus, the prediction can be updated to more accurately reflect current conditions. Furthermore, location information received from a vehicle can be employed to self-populate a database with new information. For example, a vehicle location may indicate that a vehicle is “off the map”. However, such an “off the map” condition may be encountered because the vehicle is traversing a recently completed stretch of highway or a recently opened waterway, for example. Thus, the map in the original database can be updated to reflect that a new piece of highway is available. Furthermore, the database may be updated with correlations between transportation network events and results on the route segment where the event occurred and other affected segments. At 360, a determination is made concerning whether the vehicle has completed its trip. If the determination at 360 is NO, processing returns to 320, otherwise processing concludes.

The following section facilitates understanding one example transportation asset management. A vehicle is equipped with a GPS locating device and transmitter for sending information to a central processing facility. The GPS system includes a moving map display overlaid with important transportation arteries. The GPS system is initialized at the beginning of the trip. The destination is entered, for example, by keyboard into the RPS, which includes a computer with a data recording system, display, data entry system, radio receiver, and transmitter for the telemetry. In one example, the GPS system is integrated with routing software, which removes the keyboard entry step. The RPS determines the current best possible route and sends the information (e.g., vector coordinates) to the vehicle GPS system for display to the vehicle operator. Additionally, and/or alternatively, voice devices can be employed as output devices for the routing information. Initialization sends a “start-of-trip” code back to the RPS. En route information is sent as telemetry packets from the vehicular system using, for example, the Aeris™ transmission network to the RCPU where such information is recorded, for example, every 60 seconds to the trip data base. Vehicular stops are analyzed to determine whether a trip concluded or some other interruption such as a traffic signal stop occurred. Trip conclusion can be identified as a stoppage longer than normal, for example, one exceeding ten minutes, which is located at the terminus point of the delivery. Deviations from the recommended delivery path can trigger an alert in the RPS. Alerts can include, but are not limited to, red flashing signals specific to the location of that vehicle. The vehicle operator can signal, for example, a “lost” condition, triggering an updated routing information on the vehicle moving map display. The operator can also signal by input other stoppage information like breakdown, out-of-gas, traffic congestion, lunch breaks, or a security problem, and so on.

The example systems and methods can also automatically compute routing information for routes with multiple delivery points to identify the most efficient path between such points. One example identifies such efficient paths using empirical data.

Initially, routing information can be computed based on correlating route and speed limit data stored in the data base. Refinements to an initial route can account for the safety of the vehicle, driver and cargo and/or involving user cost definitions and/or user historical data. For example, dangerous areas (e.g., bridges with a history of icing) may be circumvented in an updated route. Additionally, the safety of the community can be considered when updating a route. For example, a truck carrying explosive materials may be routed around a grade school, rather than through the school zone, and a truck carrying certain chemicals may be routed away from sensitive aquifers. Also, as a user spends more time “behind the wheel” routing decisions may be reworked to deliver the user to a suitable rest area.

As data accumulates in the database, routing information is modified to reflect real world experience at the specific time of the trip. Similarly, data can be inferred from experiences approximating given times of day and days of the week. For example, an RPS may compute an initial delivery route following a database analysis. The RPS may then scan for additional input information and determine that a snowstorm has started. The RPS calculates an alternate delivery route to avoid the storm, determining that the geographically longer trip will be shorter in duration and less hazardous. Other examples balance factors like geographic length, temporal duration, and safety according to configurable formulae. The formulae can be adapted, for example, through a user interface and/or through machine learning techniques. Furthermore, the formulae can consider user historical data. For example, for a route that spans 2000 miles, a first user may typically spend no more than 3 hours “behind the wheel” at any time while a second user may spend up to 6 hours “behind the wheel”. Thus, routing decisions may vary based on this historical data. Other historical data may record, for example, the amount above/below the speed limit or typical transit time for a segment that a user travels, the number of stops a user makes, the number of times a user misses a turn, and so on.

Another example addresses a navigational error made by a vehicle driver. Assume a vehicle operator misses a freeway exit and proceeds to the next exit. The RPS notes the deviation from the route plan and sends a notification to the RPS monitoring system. The RPS updates the route from the next available exit and transmits the routing information to the vehicle unit, which displays the new route for the operator. Other notifications include, but are not limited to, voice outputs and cellular phone communications.

Another example concerns safely routing hazardous materials. Consider a vehicle carrying a shipment of hazardous materials that is equipped with location reporting devices. During the trip, regular location, speed and other required information (e.g., tire pressure) reporting is made to controlling government agencies for tracking. Divergence from approved routing and speed conditions are alarmed for further investigation. An automatic log is provided at the conclusion of the trip for official reporting, by hard copy, telemetry and/or other means. Additionally, and/or alternatively, vehicle data can be communicated to other vehicles (e.g., state trooper, hazmat support team) to facilitate increasing data sharing concerning cargoes being transported by vehicles that employ the systems and methods described herein.

One example concerns a system for analyzing traffic data over time, which results in a detailed traffic model. This facilitates making traffic estimates and predictions for traffic based on the model, and for applying recent and real-time traffic data to the model to adjust traffic behavior predictions in the present and near future. Traffic routes are generally chosen by finding the fastest, or least time variable path through a traffic network, based on a road network database with “average segment times.” Conventionally, different segment times may be assigned to road network segments separately depending on the time of day (e.g., “rush hour” off-peak) and weekdays versus weekend days. Thus, one example facilitates computing more accurate real-time assignments of segment times, or equivalently average speeds, than is conventionally possible. Standard, proprietary, or third-party route-finding algorithms can be improved by integrating this improved real-time dataset for segment times. Furthermore, the method can propagate speed variations across the traffic network over time, so qualitatively better analysis can be done by methods including but not limited to, developing an enhanced routing algorithm that propagates travel time to employ predicted average segment speeds based on their time of day as the trip progresses, and utilizing the standard algorithms to select a configurable number of “best routes,” and then performing a time-propagating re-analysis of each candidate route to select the rate with lowest overall travel time or variance risk. Examples of route impact propagation are illustrated in FIGS. 57.

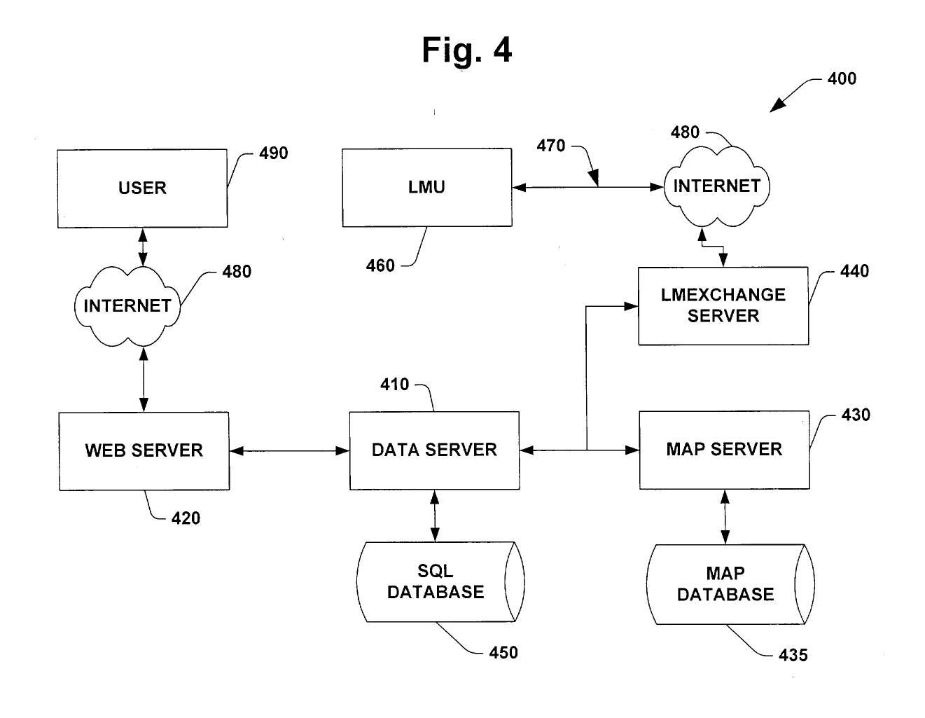

FIG. 4 illustrates one example implementation 400 of data storage and presentation in an RPS. A data server 410 is implemented using Java Database Connectivity (JDBC). It receives requests and/or data from a web server 420, a map server 430, and an LMExchange™ server 440. The data is stored and/or retrieved from an SQL database 450 (e.g. Oracle or MySQL). The web server 420 is written in Java. It interacts with remote browsers using Velocity servlets. The browser code is developed for Microsoft Internet Explorer version 5.0 or higher and is written in JavaScript and Velocity. The map server 430 is Telcontar's Drill Down Server and is used for retrieving map images, looking up addresses (geocoding and reverse geocoding) and calculating routes for comparison purposes. The LMExchange server 440 is a product of TechnoCom. It communicates with the Location Messaging Units (LMUs) 460 using TCP/IP over a cellular wireless network 470. The LMExchange server 440 communicates with the data server 410 using an XML Messaging format.

The LMU 460 transmits data to the LMExchange server 440 either as a response to a request or due to an occurrence of an event that can be remotely programmed into the LMU 460. The data is transmitted over the wireless medium using CDPD and then over the Internet 480 to the LMExchange server 440. The LMExchange server 440 converts the data to XML format and forwards the message to the data server 410. The data server 410 uses the GPS location information in the XML message and sends an address look-up request to the map server 430. The map server 430 determines the closest street address to the given location and sends the response back to the data server 410. The data server 410 then stores the data in the database 450. The new data can be used for different purposes. For example, the data can be sent to the end user 490, who could be a fleet manager, for viewing. Second, it is used to update a routing engine database.

Requests from the user 490 are sent to the web server 420 using Velocity servlets. The web server 420 processes the requests and sends data requests and/or updates to the data server 410. The web server 420 receives the appropriate data from the data server 410 and posts the response onto the Velocity servelets. The JavaScript code then dynamically generates web pages based on this data for the user 490 to view.

An example of a user request is a query for the location of a given vehicle (LMU) 460, or pinging the vehicle. When the user 490 pings a vehicle, the vehicle ID along with the command, “ping”, is sent via Velocity to the web server 420. The web server 420 then determines that a ping command has been issued and relays the command to the data server 420. The data server 410 retrieves the IP address of the device from the database, creates an XML format of the ping request, and issues a ping command to the LMExchange server 440. The LMExchange server 440 queries the appropriate LMU 460 for its location and other data that the LMU 460 is programmed to transmit upon request. The data is sent back to the data server 410 which stores it in the database 450. The web server 420 finally posts the new location information (and possibly other data) on the browser again using Velocity. The preceding is an example of an LMU 460 responding to a user request. In the following example the LMU 460 initiates a communication session because an event has occurred.

Suppose that the LMU 460 is programmed to report whenever the vehicle's speed exceeds a certain value. When this occurs the LMU 460 will transmit the information about the occurrence of this event along with the LMU's ID to the LMExchange server 440. The server 440 relays the data in the form of XML to the data server 410. The database 450 is updated and a previously user-defined action is taken. For instance, a notification email is sent to the appropriate personnel.

In addition to the map server database 435, a separate database 450 is created that keeps track of the routing information, traversed routes and so on. In one example, the segments in a transportation network are stored in the form of a directed graph. A directed graph is a collection of nodes and edges. Each edge connects two nodes in the graph in a directed manner. LMUs 460 are programmed to report their data periodically (e.g., every 10 seconds). This data is referred to here as “bread crumbs”. The LMUs 460 are also programmed to report when they depart a location and when they arrive at a location.

Using the bread crumbs, the route between two consecutive stops is determined and stored in the database 430 as a sequence of edges (road segments). The bread crumbs are also used to update the average speed and the standard deviation of speed on the corresponding road segment. A routing engine can use the updated average speeds and speed standard deviations to compute more accurate routes and to predict a more realistic route traversal time. The routing engine can also compare the computed routes with the actual routes stored in the database 450 (e.g., routes already traversed by a vehicle and determined as a result of collecting the bread crumbs). If an actual route exists, and if it is “lower cost” according to a user defined criteria, then it is presented to the user as the optimal route. It is to be appreciated that FIG. 4 illustrates one example configuration and process/data flow. Those skilled in the art will appreciate that other components and process/data flows are possible.

Static maps use static data. Dynamic maps react to real-time events and thus facilitate creating more accurate, efficient routing data. For example, average link times can be established with arbitrary time-granularity based on accumulated real-world measurements from in-vehicle GPS or other locators, including data from electronic or manual toll booth systems, roadway traffic cameras, other sensors (e.g., low orbit satellite systems), and so on. Furthermore, the correlation of data between sequential segments or nearby road segments is analyzed and stored in a database. For each nearby pair of segments, the system analyzes over time how consistently any deviation from the standard segment time on the first segment is correlated to deviations on the second segment. Thus, the relationship between segments can be considered when selecting a route.

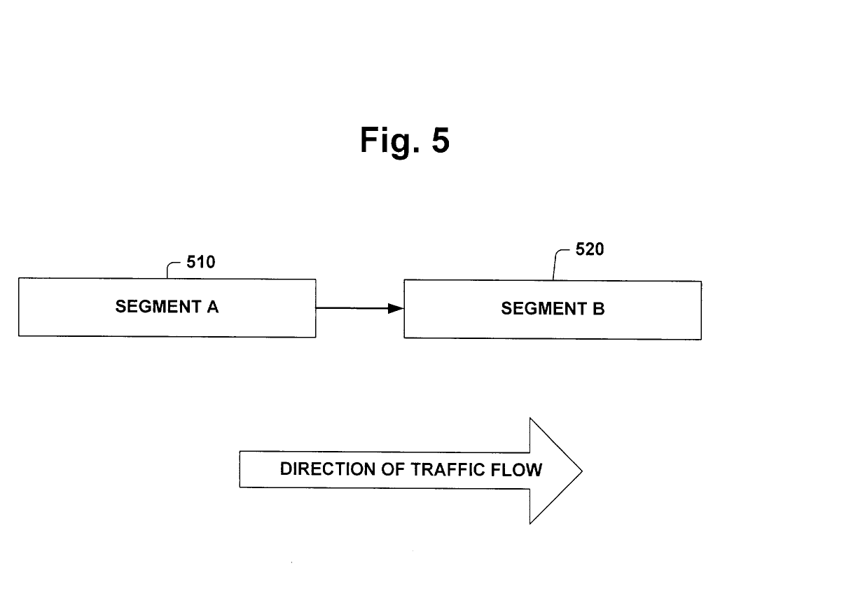

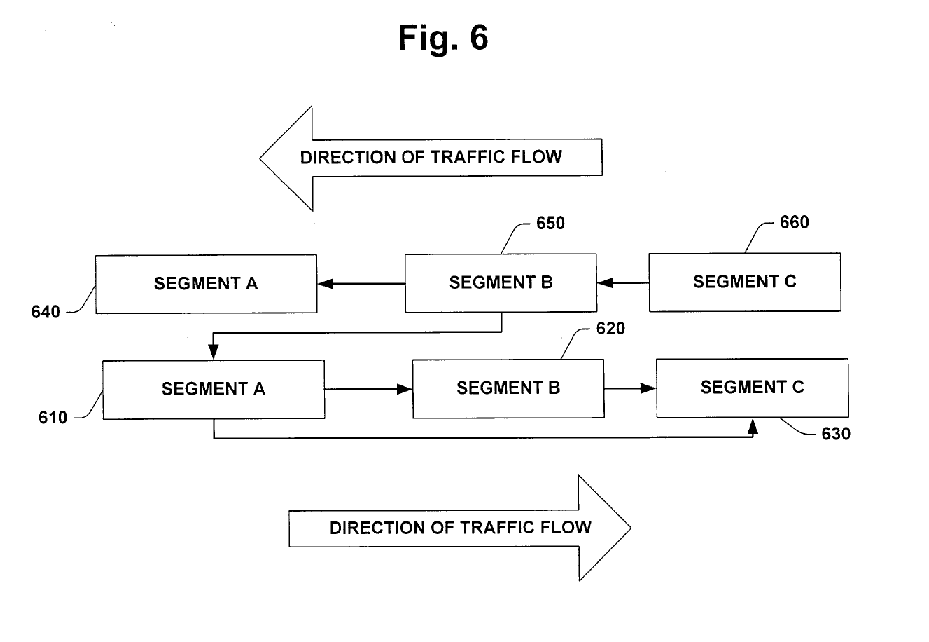

In FIG. 5, consider two road segments. Note that segments are directional, that is, a single city block of a two-way street would be represented as two segments, one for each direction (compare FIG. 6). In FIG. 5, the traffic is flowing to the east. Suppose the analysis of experience-based and third party datasets has determined that at this time of day and day of the week and under other conditions that the average speed across Segment A 510 is 49 mph, and across Segment B 520 is 51 mph. Then, suppose the system receives a data point from, for example, a vehicle based GPS unit traveling eastward on Segment B 520 reporting that the current average speed on Segment B 520 is 22 mph. This suggests that traffic on Segment A 510 will also be slower. Historical analysis will determine this correlation in terms of a weighted contribution to Segment A 510 speed, specifically, its deviation from its expected average, from this data that shows the actual speed is 29 mph below the mean.

In the real-time database of segment times/speeds, the expected speed across Segment A 510 would be reduced by a function of variables, including, but not limited to, typical average speed at Segment A 510 and Segment B 520, deviation from average speed on Segment B 520 from the average, “strength of conviction” of the speed of Segment B 520, based on the quantity and consistency of data acquired from sensors on Segment B 520, and historical consistency of the correlation between speed variations on Segment B 520 and Segment A 510.

The contributions from data-points from various nearby samples, directly correlated as above, or inferred by “chaining” the contributions across directly sequential segments, are aggregated at Segment A 510 as a weighted averages of such contributions. At each segment, the weights assigned to contributions from other segments are determined by factors including, but not limited to, rules based on direct properties of the road network topology, such as “immediately prior”, or “immediately after”, or “between 3 and 5 segments away,” analysis of historical correlations between segments based on accumulated data, and manual or heuristic assignment of priority, which may be appropriate, as one example, at complex freeway interchanges or access points. Heuristics could include the effect of a highway backup on an access ramp. These contributions may change over time, as real-world data accumulates to the point where it provides enough deterministic data to override the heuristics. Thus, an experienced based travel database can accumulate events, the results of the events, and correlations between results on related route segments to facilitate producing ever more accurate route determinations.

While FIG. 5 shows a simple case of immediately sequential road segments, no assumption of direct linkage is necessary. In FIG. 6, road segments are compared and analyzed based on their proximity, not exclusively their linkage. Slow traffic on Segment A 610 tends to indicate slow traffic on the following Segment B 620, but perhaps not with the same strength of correlation. Strong correlations between traffic speeds in segments moving in opposite directions may also contribute. Contributions from Segment C 630 to Segment A 610 can be direct, and also chained through other segments with individually strong contributions (e.g., through Segment B 620).

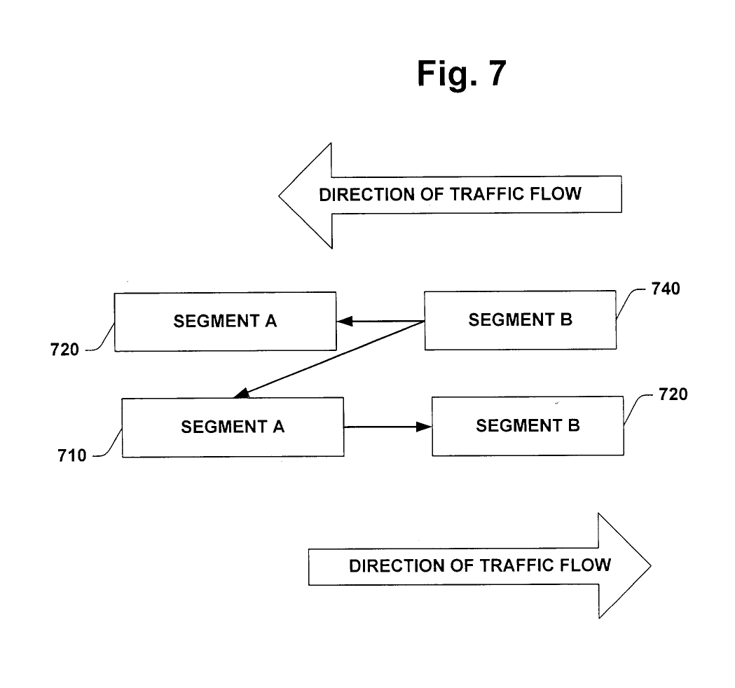

Contributions and correlations are not restricted to segments considered at a constant moment in time. In FIG. 7, a severe slow-down on Segment B 740 will have a strong influence on prior Segment A 710, especially during rush-hour as a traffic jam “propagates backward.” Thus, one example method examines correlations between road segments based on proximity of network (space) as well as nearby quantized time increments of flexibly-defined granularity. Thus, the analysis is done in a network graph space defined by the cross product of the roadway network graph with a discrete time dimension.

The statistical analysis to determine the contribution relationships discussed above, and the family of functions used to calculate contributions to segments nearby in space and time are flexibly defined. The flexible definitions facilitate different function families (e.g., linear, small polynomial) being compared as methods using an automated fitness test for the accuracy of predictions through methods by comparing predictions of methods to real-life collected data. The corresponding trade-off of computing resources (e.g., processing, memory, data storage) and performance can be optimized for business and product considerations. The flexible definitions also facilitate processing whereby within a function family, coefficients of the model at large such as the weighted contribution of a segment “two links away” compared to the contribution of an adjacent link can be optimized through automated comparisons of fitness based on comparing predictions against real-world measurements.

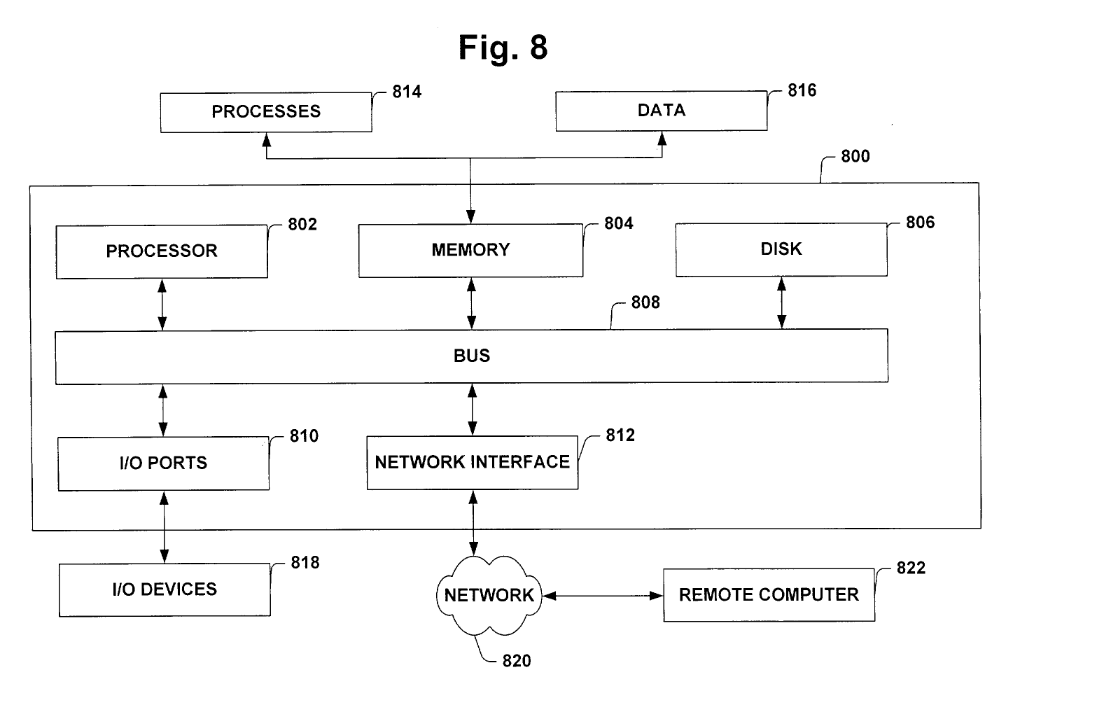

FIG. 8 illustrates a computer 800 that includes a processor 802, a memory 804, a disk 806, input/output ports 810, and a network interface 812 operably connected by a bus 808. Executable components of the systems described herein may be located on a computer like computer 800. Similarly, computer executable methods described herein may be performed on a computer like computer 800. It is to be appreciated that other computers may also be employed with the systems and methods described herein. The processor 802 can be a variety of various processors including dual microprocessor and other multi-processor architectures. The memory 804 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 806 can include, but is not limited to, devices like a magnetic disk drive, a floppy disk drive, a tape drive, a Zip drive, a flash memory card, and/or a memory stick. Furthermore, the disk 806 can include optical drives like, compact disk ROM (CD-ROM), a CD recordable drive (CD-R drive), a CD rewriteable drive (CD-RW drive) and/or a digital versatile ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus architectures. The bus 808 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 interacts with input/output devices 818 via input/output ports 810. Input/output devices 818 can include, but are not limited to, a keyboard, a microphone, a pointing and selection device, cameras, video cards, displays, and the like. The input/output ports 810 can include but are not limited to, serial ports, parallel ports, and USB ports.

The computer 800 can operate in a network environment and thus is connected to a network 820 by a network interface 812. Through the network 820, the computer 800 may be logically connected to a remote computer 822. The network 820 can include, but is not limited to, local area networks (LAN), wide area networks (WAN), and other networks. The network interface 812 can connect to local area network technologies including, but not limited to, fiber distributed data interface (FDDI), copper distributed data interface (CDDI), ethernet/IEEE 802.3, token ring/IEEE 802.5, and the like. Similarly, the network interface 812 can connect to wide area network technologies including, but not limited to, point to point links, and circuit switching networks like integrated services digital networks (ISDN), packet switching networks, and digital subscriber lines (DSL).

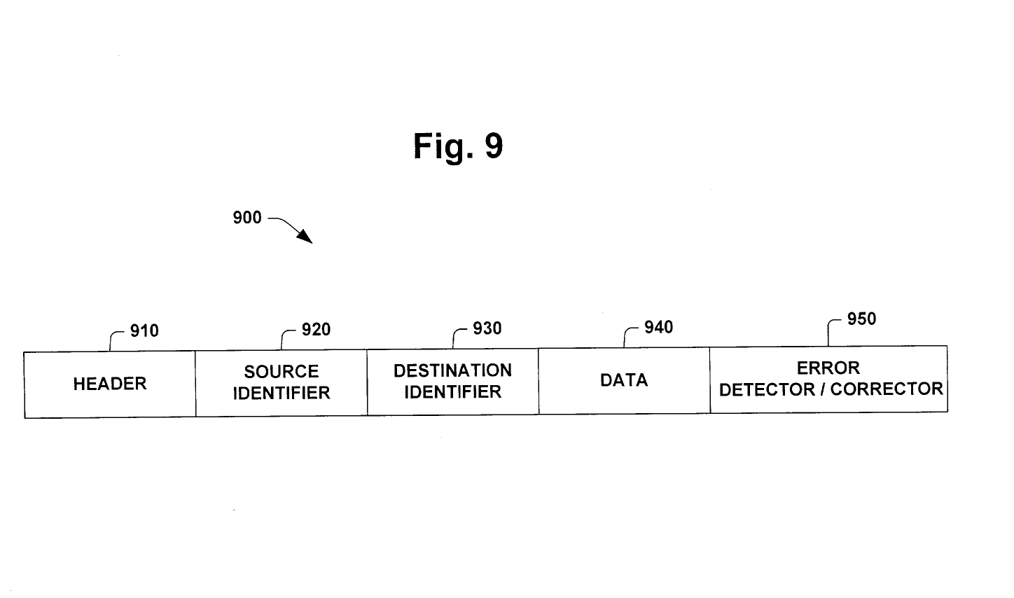

Referring now to FIG. 9, information can be transmitted between various computer components associated with managing transportation assets as described herein via a data packet 900. An exemplary data packet 900 is shown. The data packet 900 includes a header field 910 that includes information such as the length and type of packet. A source identifier 920 follows the header field 910 and includes, for example, an address of the computer component from which the packet 900 originated. Following the source identifier 920, the packet 900 includes a destination identifier 930 that holds, for example, an address of the computer component to which the packet 900 is ultimately destined. Source and destination identifiers can be, for example, globally unique identifiers (guids), URLS (uniform resource locators), path names, and the like. The data field 940 in the packet 900 includes various information intended for the receiving computer component. The data packet 900 ends with an error detecting and/or correcting 950 field whereby a computer component can determine if it has properly received the packet 900. While six fields are illustrated in the data packet 900, it is to be appreciated that a greater and/or lesser number of fields can be present in data packets.

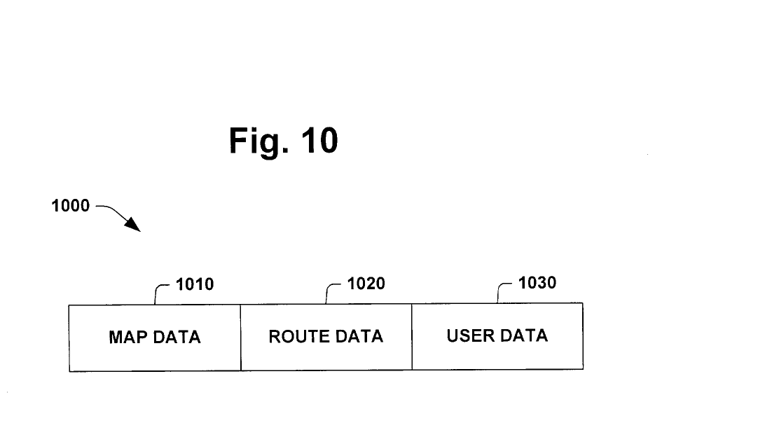

FIG. 10 is a schematic illustration of sub-fields 1000 within the data field 950 (FIG. 9). The sub-fields 1000 discussed are merely exemplary and it is to be appreciated that a greater and/or lesser number of sub-fields could be employed with various types of data packets germane to managing transportation assets. The sub-fields 1000 include a field 1010 that holds map data. The map data may be historical data and/or real-time updates, for example. The illustrated subfields 1000 also include a route data field 1020 that stores data concerning a (re)computed route and/or instant conditions along a segment of that route, for example. The illustrated subfields 1000 also include a user data field 1030 that stores data concerning a user profile and/or user instant conditions (speed, direction, number of hours at the wheel), for example.

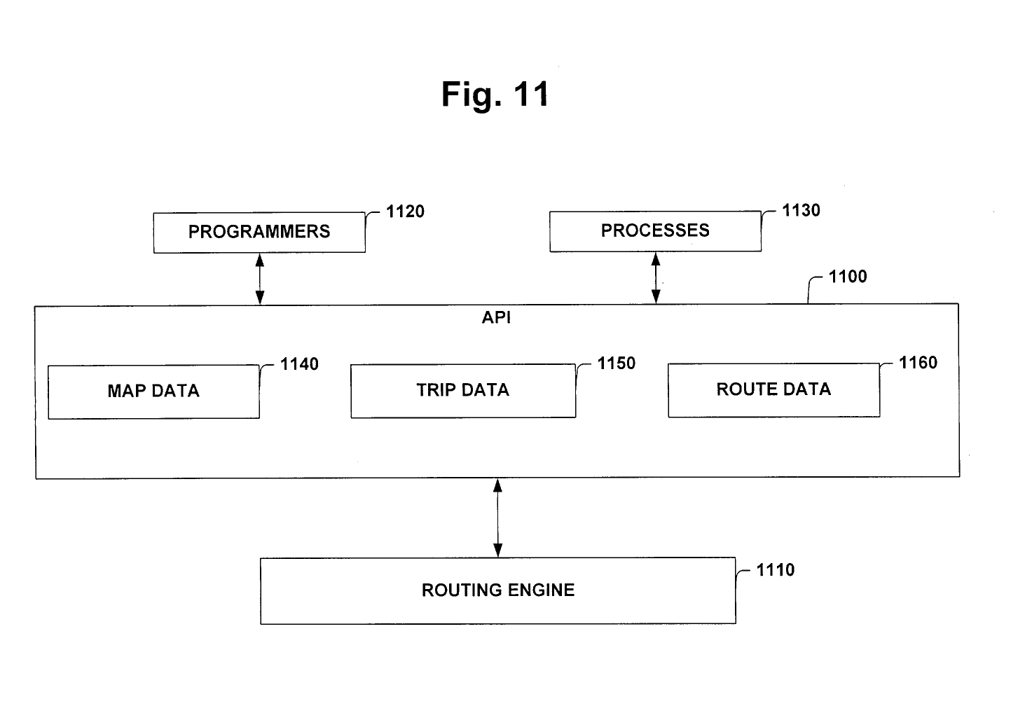

Referring now to FIG. 11, an application programming interface (API) 1100 is illustrated providing access to a routing engine 1110. The API 1100 can be employed, for example, by programmers 1120 and/or processes 1130 to gain access to processing performed by the routing engine 1110. For example, a programmer 1120 can write a program to access the routing engine 1110 (e.g., to invoke its operation, to monitor its operation, to access its functionality) where writing a program is facilitated by the presence of the API 1100. Thus, rather than the programmer 1120 having to understand the internals of the routing engine 1110, the programmer's task is simplified by merely having to learn the interface to the API 1100. This facilitates encapsulating the functionality of the routing engine 1110 while exposing that functionality. Similarly, the API 1100 can be employed to provide data values to the routing engine 1110 and/or retrieve data values from it. For example, a process 1130 that generates map information can provide real-time data to the routing engine 1110 via the API 1100 by, for example, using a call provided in the API 1100. Thus, in one example of the API 1100, a set of application program interfaces can be stored on a computer-readable medium. The interfaces can be executed by a computer component to gain access to a routing engine 1110. Interfaces can include, but are not limited to, a first interface 1140 that communicates a map data associated with a transportation network, a second interface 1150 that communicates a trip data associated with a journey through the network mapped in the map data, and a third interface 1160 that communicates a route data generated from the map data and the trip data.

The systems, methods, and objects described herein may be stored, for example, on a computer readable media. Media can include, but are not limited to, an ASIC, a CD, a DVD, a RAM, a ROM, a PROM, a disk, a carrier wave, a memory stick, and the like. Thus, an example computer readable medium can store computer executable instructions for a method for managing transportation assets. The method includes computing a route for a transportation asset based on analysis data retrieved from an experience based travel database. The method also includes receiving real-time data from the transportation asset and updating the route for the transportation asset based on integrating the real-time data with the analysis data.

What has been described above includes several examples. It is, of course, not possible to describe every conceivable combination of components or methodologies for purposes of describing the systems, methods, computer readable media and so on employed in managing transportation assets. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

While the systems, methods and so on herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

Furthermore, to the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (e.g., A or B) it is intended to mean “A or B or both”. When the author intends to indicate “only A or B but not both”, then the author will employ the term “A or B but not both”. Thus, use of the term “or” herein is the inclusive, and not the exclusive, use. See BRYAN A. GARNER, A DICTIONARY OF MODERN LEGAL USAGE 624 (2d Ed. 1995).

What is claimed is:

1. A method for managing transportation assets, comprising:
accessing an experience based travel database;
computing a route through a mapped transportation network for a transportation asset based, at least in part, on an analysis data retrieved from the experience based travel database;
receiving a real-time data from one or more of the transportation asset and one or more sensors that monitor one or more route segments in the mapped transportation network; and
updating the route for the transportation asset based, at least in part, on integrating the real-time data with the analysis data.

2. The method of claim 1, comprising:
updating the experience based travel database by passively collecting route information from one or more transportation assets as they traverse the mapped transportation network; and
programmatically organizing the route information to facilitate computing a route.

3. The method of claim 2, where updating the experience based travel database comprises:
collecting a real-time event data associated with an event that affects one or more segments of the mapped transportation network;
analyzing the effect of the event on a computed route; and
programmatically updating the route information organized in the experience based travel database.

4. The method of claim 1, where computing a route comprises:
producing one or more candidate routes that minimize one or more costs associated with traveling a candidate route based, at least in part, on data stored in the experience based travel database.

5. The method of claim 4, where computing a route comprises employing a stochastic model updated with real-time data to evaluate the one or more candidate routes.

6. The method of claim 1, where the one or more sensors include satellite based sensors.

7. A computer readable medium storing computer executable instructions operable to perform the method of claim 1.

8. A system that facilitates managing one or more transportation assets, comprising:
an experience based database;
a stochastic model that models a transportation space based on data stored in the experience based database;
a receiver for receiving at least one of a transportation asset location data and a transportation asset telemetry data associated with a transportation asset operating in the transportation space;
a processor that, substantially in real-time, computes or recomputes a route for a trip based, at least in part, on evaluating the stochastic model in light of the location data and the telemetry data; and
a transmitter that transmits the route for the trip.

9. The system of claim 8, where the experience based database stores a static map data and a dynamic map data, and where the database is updateable by the received location data and the received telemetry data.

10. The system of claim 9, where the database receives and aggregates real-time traffic data and selectively updates the dynamic map data based on the aggregated real-time traffic data.

11. The system of claim 10, where the database stores a vehicle data comprising a vehicle location, a vehicle direction, a vehicle speed, a vehicle source, and a vehicle destination.

12. The system of claim 11, where the database stores a user profile data comprising a user cost definition and a user historical data.

13. A computer readable medium storing computer executable components of the system of claim 12.

14. A system for reducing variability in a vehicle arrival time, comprising;
a historical database that stores a map data, a trip data, a selected route data, a real-time route data, and a real-time vehicle data; and
a receiving system that receives the real-time vehicle data, accesses the historical database, and computes or recomputes a predicted vehicle arrival time and one or more updated vehicle routes that facilitate reducing the variability in vehicle arrival time, based on the real-time vehicle data, the map data, the trip data, the selected route data, and the real-time route data.

15. The system of claim 14, where the receiving system recomputes a route by evaluating the effect of one or more traffic events modeled in the real-time route data on one or more route segments modeled in the map data.

16. A computer readable medium storing computer executable instructions operable to perform a method for managing transportation assets, the instructions comprising:
instructions to compute a route for a transportation asset based, at least in part, on an analysis data retrieved from an experience based travel database;
instructions to receive a real-time data from the transportation asset; and
instructions to update the route for the transportation asset based, at least in part, on integrating the real-time data with the analysis data.

17. A set of application program interfaces embodied on a computer readable medium for execution on a computer in conjunction with an application program that facilitates improving transportation asset management, comprising:
a first interface that communicates a map data;
a second interface that communicates a trip data; and
a third interface that communicates a route data, where the route data is based on analysis of the map data and the trip data, where the map data includes dynamically updated map data, where the dynamic map updates are based on data collected passively from one or more vehicles.

18. A computer readable medium having stored thereon a data structure comprising:
a first field containing a map data for a route;
a second field containing a predicted travel time for the route;
a third field containing one or more coefficients employed in equations evaluated in predicting the travel time for the route; and
a fourth field containing a real-time event data associated with one or more events that are analyzed to update the one or more coefficients.

19. A system, comprising:
means for building a stochastic model of a transportation network with real-time updateable simulation coefficients;
means for updating the stochastic model based on real-time data received from the transportation network; and
means for dynamically computing or recomputing a trip route from the stochastic model.
